(19) United States
(12) Patent Application Publication
(10) Pub. No.: US 2007/0249328 A1
(43) Pub. Date: Oct. 25, 2007

(54) Method and apparatus for session negotiation in a mobile communication system and system thereof

(75) Inventors: Jung-soo Jung, Seongnam-si (KR); Dae-Gyun Kim, Seongnam-si (KR); Beom-Sik Bae, Suwon-si (KR); Prasad TSV Vadlapudi, New Tippassandra (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/725,228

(22) Filed: Mar. 16, 2007

(30) Foreign Application Priority Data
Mar. 16, 2006 (KR) 24557/2006

(51) Int. Cl. H04Q 7/24

(52) U.S. Cl. 455/414.1; 370/329

(57) ABSTRACT

Provided is a method and apparatus in a mobile communication system, which can achieve efficient session negotiation when an Access Terminal (AT) and an Access Network Transceiver System (ANTS) of the mobile communication system have different parameters for a session setup therebetween. The method includes selecting a configuration attribute from among configuration attributes for session negotiation, determining if the AT and the session controller have assured to use an enhanced configuration request message for the selected configuration attribute, and if so, the AT transmits an enhanced configuration request message including an identifier of the selected configuration attribute without a list of attribute values that the AT wants to use for the selected configuration attribute to the session controller.

### PRIORITY

This application claims the benefit under 35 U.S.C. §119(a) of an application entitled “Method And Apparatus For Session Negotiation In A Mobile Communication System, And Mobile Communication System For The Same” filed in the Korean Industrial Property Office on Mar. 16, 2006 and assigned Serial No. 2006-24557, the contents of which are incorporated herein by reference.

### BACKGROUND OF THE INVENTION

1. Field of the Invention

The present invention relates generally to a method and an apparatus for session negotiation in a mobile communication system, and more particularly to a method and apparatus in a mobile communication system, which can achieve efficient session negotiation when an Access Terminal (AT) and an Access 20 Network Transceiver System (ANTS) of the mobile communication system have different parameters for a session setup therebetween.

2. Description of the Related Art

Wireless communication systems have generally been developed to handle situations in which it is impossible to connect a fixed wire network to an AT. Representative examples of such wireless communication systems include a mobile communication system, a wireless Local Area Network (LAN), a Wireless broadband (Wibro) system and a mobile Ad Hoc system.

In contrast to ordinary wireless communication, mobile communication is based on user mobility. The goal of a mobile communication system is to enable exchange of information media through a terminal, such as a mobile phone and a wireless pager, regardless of time, location and parties involved.

A cellular mobile communication system has a service area divided into multiple cells, each of which has one wireless ANTS (cellular ANTS) allocated a different frequency from that of a neighbor cell ANTS, to enable frequency reuse. A service area controlled by one wireless ANTS herein is called a “cell,” and a system including cells as unit service areas is called a cellular system.

Analog cellular systems, such as Advanced Mobile Phone System (AMPS) and Total Access Communication Services (TACS), appeared first and are thus called the first (1^{st}) generation mobile communication systems. The rapid increase of mobile communication service subscribers required service beyond the capability of the first generation mobile communication systems, and the technological development caused increase in the demand for various services beyond the conventional voice service. Such requirements brought the second generation (2G) digital mobile communication system to fruition. In contrast to the analog system, the 2G mobile communication systems digitalize an analog voice signal, and encode and modulate/demodulate the signal. The 2G system uses a frequency of 800 MHz, and Time Division Multiple Access (TDMA) and Code Division Multiple Access (CDMA) multiple access schemes. The 2G system provides a voice service and a low speed data service, and includes the IS-95 (CDMA scheme) and IS-54 (TDMA scheme) of the United States and the Global System for Mobile (GSM) communication scheme of Europe. Further, the Personal Communication Services (PCS) systems are defined as the 2.5^{th} generation mobile communication systems and use a frequency of 1.8˜2 GHz band. The 2G mobile communication systems as described have been constructed to increase the efficiency of the mobile communication systems while providing a voice service to users. However, the advent of the Internet and the users' requirement for a higher speed data service caused to be generated a new wireless platform, which includes the Third generation (3G) mobile communication system, such as International Mobile Telecommunication-2000 (IMT-2000). The IMT-2000 systems are divided into synchronous and asynchronous systems. Representative asynchronous systems include Universal Mobile Telecommunication Systems (UMTS) and Wideband CDMA (WCDMA) systems of the 3G Partnership Project (3GPP), and representative synchronous systems include CDMA 2000 1x, CDMA 2000 1x Evolution Data Only (EV-DO) and CDMA 2000 1x Evolution Data and Voice (EV-DV) of the 3G Partnership Project 2 (3GPP2).

CDMA 2000 1x uses an IS-95C network evolved from the existing IS-95A and IS-95B network, to provide a data service at a downlink data rate of 144 kbps, which is faster than the 14.4 kbps/56 kbps data rate of the IS-95A/IS-95B network. Further, the CDMA 2000 1x EV-DO has been arranged by one-step evolving the CDMA 2000 1x to support a downlink data rate of 2.4 Mbps, and the CDMA 2000 1x EV-DV has been arranged to overcome the problems of the CDMA 2000 1x EV-DO and simultaneously support both voice and data service.

The CDMA 2000 1x EV-DO system is a representative mobile communication system having a channel structure for high speed data transmission, which has been proposed by the 3GPP2 to improve the data communication of the IS-2000 system.

In the CDMA 2000 1x EV-DO system, data communication can be classified into downlink and uplink communication. As used herein, the downlink refers to a direction from an ANTS to an AT, and the uplink refers to a direction from an AT to an ANTS. Hereinafter, a structure of a downlink channel of the CDMA 2000 1x EV-DO system will be discussed. The downlink channel includes a pilot channel, a downlink Medium Access Control (MAC) channel, a downlink traffic channel and a downlink control channel, which may be transmitted after being time-division-multiplexed. As used herein, a bundle of signals transmitted after being time-division-multiplexed is referred to as a “burst.”

From among the channels described above, user data packets are transmitted in the downlink traffic channel, and control messages and user data packets are transmitted in the downlink control channel. Further, the downlink AC channel is used for control of uplink data rate, transfer of power control information or appointment of downlink data transmission channel.

In contrast to the downlink channel, the uplink channel used in the CDMA 2000 1x EV-DO system uses different identifiers according to ATs. Therefore, the uplink channels described below are transmitted to an ANTS with different identifiers for the ATs. The uplink channels include a pilot channel, an uplink traffic channel, an access channel, a Data Rate Control (DRC) channel and a Reverse Rate Indicator (RRI) channel.

Hereinafter, functions of the uplink channels will be briefly discussed. Similarly to the downlink traffic channel, an uplink user data packet is transmitted in the uplink traffic channel. Further, the DRC channel is used in order to indicate a downlink data rate that can be supported by the AT, and the RRI channel is used in order to indicate a data rate of a data channel transmitted in an uplink. Further, the access channel is used when the AT transmits a message or traffic to the ANTS before the connection of the traffic channel.

FIG. 1 illustrates a conventional CDMA 2000 1x EV-DO mobile communication system.

In FIG. 1, reference numeral 100 denotes ATs 100a, 100b and 100c, reference numeral 110 denotes ANTSs 110a and 110b and reference numeral 120 denotes Access Network Controllers (ANCs) 120a and 120b. A first ANTS 110a communicates with a plurality of ATs 110a and 110b, a first ANTS 110a is connected to a first ANC 120a, and a second ANTS 110b is connected to a second ANC 120b. Further, ANCs 120a and 120b may be connected to two or more ANTSs. For convenience of description, FIG. 1 illustrates one ANTS connected to one ANC. In this manner, the ANCs 120a and 120b are connected to a Packet Data Service Node (PDSN) 130, which is connected to the Internet network 140.

In a mobile communication system illustrated in FIG. 1, each of the ANTSs 110a and 110b transmits packet data only to an AT having the optimal packet data rate from among ATs located within its own area, which will be described in more detail hereinafter. In the following description, the AT is designated by reference numeral 100, and the ANTS is designated by reference numeral 110.

In the case of downlink data rate control, the AT 100 measures a reception intensity of a pilot channel transmitted by the ANTS 110, and determines the downlink data rate at which the ATs 100 will receive downlink data based on the measured reception intensity of the pilot channel. Thereafter, the AT 100 transmits DRC information corresponding to the determined downlink data rate to the ANTS 110 through a data rate control channel. Then, the ANTS 110 receives the DRC information from all ATs located within its area and are expected to perform communication within the area. The DRC information refers to a value corresponding to a downlink transmissible data rate, which is determined based on a channel state measured by an AT in a good channel state. The relation between the downlink channel state and the DRC information is determined to have a fixed value during the manufacture of the AT, while it may change according to the actual application.

In contrast to the IS-2000 system, the CDMA 2000 1x EV-DO system illustrated in FIG. 1 does not use a physical identifier such as an Electronic Serial Number (ESN) of the AT 100 to identify the AT 100. Instead, the CDMA 2000 1x EV-DO system identifies the AT 100 by providing a connection identifier named “Unicast Access Terminal Identifier (UATI) to each AT 100. The UATI is independently defined for each subnet, that is, for each area that is controlled by a Radio Network Controller (RNC) or a Packet Control Function (PCF) unit, which are not shown in FIG. 1. The UATI includes a subnet identifier part having a size of 8 bits and an AT identifier part having a size of 24 bits. Therefore, when the AT 100 of the CDMA 2000 1x EV-DO system moves from a source subnet to a target subnet, a PCF unit or RNC allocates a new UATI including a new subnet identifier to the AT 100. The ANTS 110 and the ANC 120 are referred to as an Access Network (AN) 150.

The AT 100 of the CDMA 2000 1x EV-DO system must be allocated a UATI, an identifier of the AT 100, in order to exchange data with the system. After being allocated the UATI, the AT 100. negotiates with the AN 150 about parameters according to protocols of each layer necessary for exchange of data between the AT 100 and the AN 150, which include a method of exchanging data through a physical channel between the AT 100 and the AN 150, a method of determining and transmitting a transport type and format by the MAC layer, a method of maintaining a setup call or transmitting/receiving data in an idle state in a connection layer and a method of separating, rearranging and re-transmitting upper layer data, such as Transmission Control Protocol/Internet Protocol (TCP/IP) packets, in an application layer.

While negotiating the system parameters, the AT and the AN exchange pre-defined messages, and set a dedicated channel for the message exchange. The dedicated channel is established before the exchange of the parameters necessary for the transmission. Therefore, the AT and the AN perform the parameter negotiation after setting a dedicated traffic channel by using initially set parameters.

In the CDMA 2000 1x EV-DO system, a data structure with a format named “configuration attribute” is used for the parameters according to the protocols to be used by the AT and the AN. The configuration attribute includes an attribute Identifier (ID) and an attribute value. When the AN 150 and the AT 100 negotiate the parameters, they propose and negotiate parameter values for use by using corresponding configuration attributes, and store a negotiation result as a corresponding configuration attribute.

A set of the negotiated configuration attributes as described above is defined as a “session configuration,” and a process of negotiating the session configuration is called a “session configuration process.” The negotiated session configuration is maintained and updated during one session, that is, during a time interval in which data communication between the AT 100 and the AN 150 is possible.

In the CDMA 2000 1x EV-DO system, before starting the session configuration, the AN 150 and the AT 100 generate a configuration instance dedicated for session configuration, which is responsible for session configuration of each of the protocol and applications. The configuration instance of the generated specific protocol (or application) performs negotiation of configuration attributes defined for the protocol. After generating the configuration instance for each of the protocol and applications, the AN 150 and the AT 100 proceed with a session configuration process.

The session configuration process between the AT 100 and the AN 150 can be divided into an Access Terminal initiated state (AT-initiated state) in which the AT 100 requests necessary configuration attributes, and an Access Network initiated state (AN-initiated state) in which the AN 150 proposes configuration attributes to be used. The AT 100 and the AN 150 transmit a configuration request message including a list of parameters to be used for one configuration attribute.

The party having received the configuration request message continuously selects a desired parameter from the parameter list, and finally configures all system parameters with parameter values supported by the AT 100 and the AN 150. Through this process, the AT 100 and the AN 150 perform the parameter negotiation for all the protocols to be used, and the party that requested the parameter configuration transfers a configuration complete message to the receiving party, thereby completing the session configuration process. Further, after completing the session configuration, the AT 100 and the AN 150 release the traffic channel configured with the initially set parameters, and apply newly negotiated parameters.

FIG. 2 illustrates a session configuration process between the AT 100 and the AN 150 in a conventional CDMA 2000 1x EV-DO system.

In step 200, the AT 100 and the AN 150 establish a dedicated channel by using configuration attributes of a currently used session or initial parameters in order to configure a session. In step 202, the AT 100 and the AN 150 proceed with a session negotiation in an AT-initiated state, and the AT 100 notifies completion of the AT-initiated state by transmitting a configuration complete message when the configuration attribute request of the AT 100 is satisfied.

In step 204, the AT 100 and the AN 150 proceed with the session negotiation in an AN-initiated state. When the configuration attribute request of the AT 100 is satisfied, the AN 150 notifies completion of the session negotiation by transmitting a configuration complete message including session information to be newly applied. In step 206, the AT 100 and the AN 150 terminate the connection of the dedicated channel in order to apply a new session. Then, in step 208, the AT 100 and the AN 150 apply the session initiated by the AN 150, thereby completing the session configuration process.

FIG. 3 illustrates a session configuration process between the AT 100 and the AN 150 in a conventional CDMA 2000 1x EV-DO system.

In step 300, the AT 100 is allocated a new UATI through processes including UATI request, UATI allocation and UATI completion between the AT 100 and the AN 150. In step 302, the AT 100 and the AN 150 opens a session by using initial attribute values. Then, in step 304, the AT 100 and the AN 150 configure a traffic channel by using the initial parameter values of step 302. In step 306, the AT 100 and the AN 150 start the session negotiation. In step 308, the AN 150 starts a session configuration process of an AT-initiated state by transmitting a configuration start message to the AT 100 by using the traffic channel configured in step 304. In step 310, the AT 100 exchanges a configuration request message and a configuration response message with the AN 150 several times and then sets a desired value for a specific configuration attribute. After completing configuration of a desired configuration attribute value, the AT 100 notifies completion of the AT initiated state and start of an AN-initiated state by transmitting a configuration complete message to the AN 150 in step 312.

In step 314, the AN 150 provides encryption key values to the AT 100. In step 316, the AN 150 exchanges a configuration request message and a configuration response message with the AT 100, thereby configuring a desired value for a specific configuration attribute. After configuring a desired value for a specific configuration attribute, the AN 150 transmits, in step 318, a configuration complete message to the AT 100, thereby completing the entire session configuration process and instructing which session will be used. Then, in step 320, the session is reconfigured.

According to the prior art as described above with reference to FIGS. 2 and 3, the AT must notify the AN of all supportable values for each configuration attribute in an AT-initiated state, and the AN must select a desired value to be used from among the values that can be supported by the AT. However, the information of the supportable values for a particular configuration attribute, which can be supported by the AT, may be too large, so that it may be impossible for the AT to properly notify the AN of all of the information.

### SUMMARY OF THE INVENTION

Accordingly, the present invention has been made to solve the above-mentioned problems occurring in the prior art, and the present invention provides a method, an apparatus, and a system thereof, by which an AN can appoint a value that is not requested by an AT in an AT-initiated state in a session negotiation process between the AT and the AN.

The present invention provides a method, an apparatus, and a system thereof, for more efficient session negotiation, even when the AT and the session controller want to use different configuration attribute values in a mobile communication system storing and managing session configuration information.

In accordance with the present invention, there is provided a method for session negotiation by an AT in a mobile communication system, the method including selecting a configuration attribute for which negotiation has not been completed, from among configuration attributes for session negotiation between the AT and a session controller during the session negotiation in an AT-initiated state, determining whether the AT and the session controller have assured their use of an enhanced configuration request message for the selected configuration attribute, and when the AT and the session controller have assured their use of an enhanced configuration request message for the selected configuration attribute, transmitting by the AT an enhanced configuration request message including an identifier of the selected configuration attribute without a list of attribute values that the AT wants to use for the selected configuration attribute, to the session controller.

In accordance with the present invention, there is provided a method for session negotiation by a session controller in a mobile communication system, the method including determining whether the AN has received a message from an AT during a session configuration process between the AT and the session controller in an AT-initiated state of the AT, and when a received message is an enhanced configuration request message, which includes an identifier of a list of attribute values that the AT wants to use, inserting an attribute identifier included in the enhanced configuration request message and an attribute value that the session controller wants to use into an enhanced configuration response message corresponding to the enhanced configuration request message, and then transmitting the enhanced configuration response message to the AT.

In accordance with the present invention, there is provided a method for session negotiation in a mobile communication system, the method including selecting a configuration attribute by an AT for session negotiation between the AT and a session controller during the session negotiation in an AT-initiated state, when the AT and the session controller have assured their use of an enhanced configuration request message for the selected configuration attribute, transmitting by the AT an enhanced configuration request message including an identifier of the selected configuration attribute without a list of attribute values that the AT wants to use for the selected configuration attribute to the session controller, when the session controller has received the enhanced configuration request message, inserting an attribute identifier included in the enhanced configuration request message and an attribute value that the session controller ants to use into an enhanced configuration response message corresponding to the enhanced configuration request message, and then transmitting the enhanced configuration response message to the AT by the session controller, and receiving the enhanced response message and performing by the AT session negotiation with the configuration attribute value included in the enhanced configuration response message.

In accordance with the present invention, there is provided a system for performing session negotiation in a mobile communication system, the system including an AT for selecting a configuration attribute describing parameters to be used for each protocol for session negotiation between the AT and a session controller during the session negotiation in an AT-initiated state, and transmitting an enhanced configuration request message including an identifier of the selected configuration attribute without a list of attribute values that the AT wants to use for the selected configuration attribute to the session controller when the AT and the session controller have promised to use an enhanced configuration request message for the selected configuration attribute, and the session controller for receiving the enhanced configuration request message from the AT, inserting an attribute identifier included in the enhanced configuration request message and an attribute value that the session controller wants to use into an enhanced configuration response message corresponding to the enhanced configuration request message, and then transmitting by the session controller the enhanced configuration response message to the AT.

In accordance with the present invention, there is provided an apparatus for performing session negotiation in order to perform communication with an AT in a mobile communication system, the apparatus including a transceiver unit for performing wireless communication with the AT; and a session controller for inserting, when an enhanced configuration request message is received, which includes an identifier of a configuration attribute a list of attribute values that the AT wants to use, an attribute identifier included in the enhanced configuration request message and an attribute value that the session controller wants to use into an enhanced configuration response message corresponding to the enhanced configuration request message, transmitting the enhanced configuration response message to the AT, and storing attribute values for the session configuration between the AT and the session controller.

In accordance with the present invention, there is provided an AT apparatus for performing session negotiation in a mobile communication system, the apparatus including a transceiver unit for performing wireless communication with an ANTS, a controller for selecting a configuration attribute for which negotiation has not been completed, from among configuration attributes for session negotiation between an AT and a session controller during the session negotiation in an AT-initiated state, transmitting an enhanced configuration request message including an identifier of the selected configuration attribute without a list of attribute values that the AT wants to use for the selected configuration attribute through the transceiver unit, and, when an enhanced configuration response message including an identifier included in the enhanced configuration request message and attribute values that the session controller wants to use for the selected configuration attribute has been received through the transceiver unit, storing a configuration attribute value included in the enhanced configuration response message, and a memory for storing information on the negotiated session configuration, an identifier of the selected configuration attribute, and the configuration attribute value included in the enhanced configuration response message.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a conventional CDMA 2000 1x EV-DO mobile communication system;

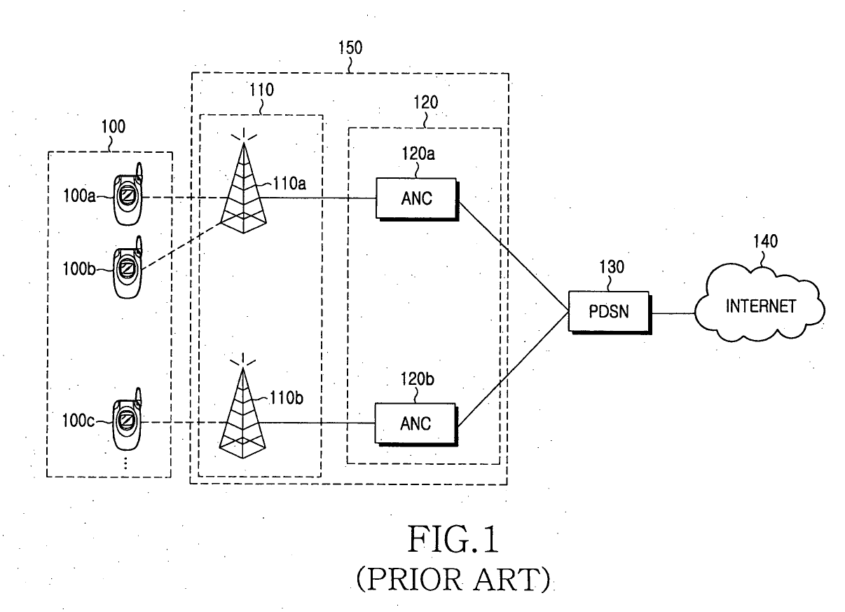

FIG. 2 illustrates a session configuration process between an AT and an AN in a conventional CDMA 2000 1x EV-DO system;

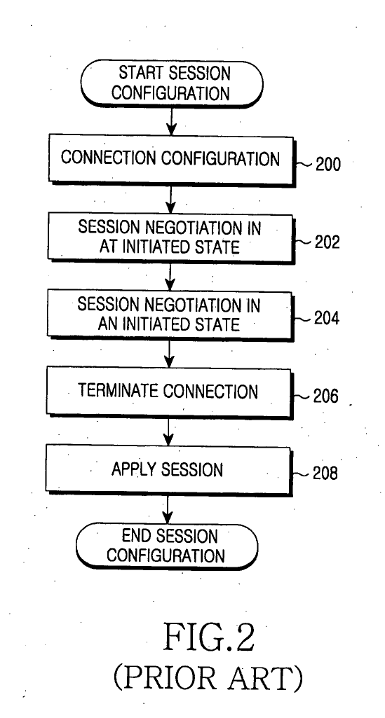

FIG. 3 illustrates a session configuration process between an AT and an AN in a conventional CDMA 2000 1x EV-DO system;

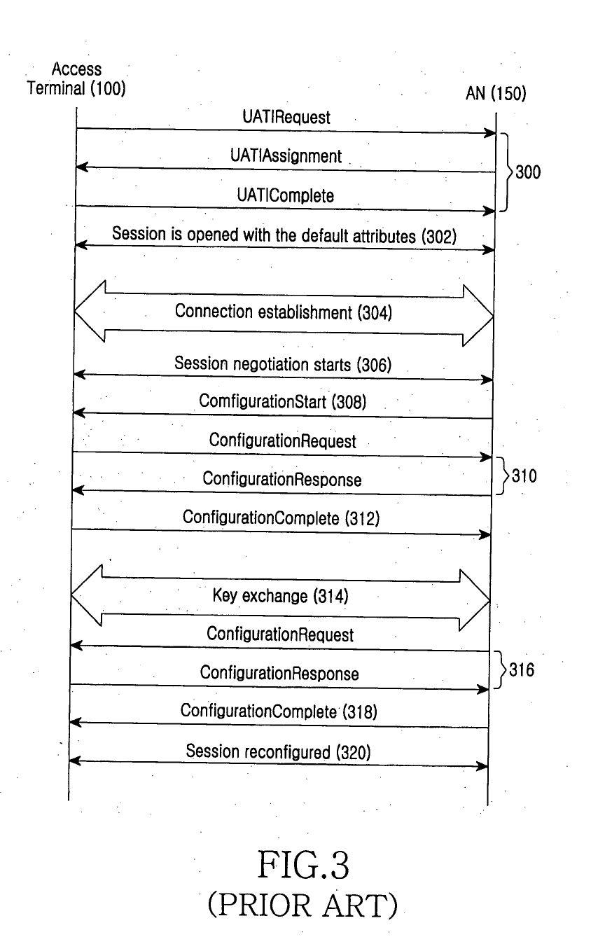

FIG. 4 illustrates an operation of a protocol configuration instance by an AT in an AT-initiated state according to the present invention;

FIG. 5 illustrates an operation of a protocol configuration instance by an AN in an AT-initiated state according to the present invention; and

FIG. 6 illustrates a construction of a mobile communication system according to the present invention, for example, a CDMA 2000 1x EV-DO network.

### DETAILED DESCRIPTION OF THE PREFERRED EMBODIMENTS

Hereinafter, preferred embodiments of the present invention will be described with reference to the accompanying drawings. In the following description, a detailed description of known functions and configurations incorporated herein will be omitted for the sake of clarity and conciseness. Further, various specific definitions found in the following description are provided only to assist in the general understanding of the present invention, and it will be apparent to those skilled in the art that the present invention can be implemented without such definitions.

A process for session negotiation through various system parameters necessary for communication between an AT and an AN can generally be divided into an AT-initiated state in which the AT requests the necessary parameter values to the AN, and an AN-initiated state in which the AN discloses to the AT the parameter values to be used. Hereinafter, an ANTS and an ANC are referred to as an Access Network (AN).

According to the present invention, when it is impossible for an AT to notify all supportable values for a specific configuration attribute to an AN in an AT-initiated state of a session negotiation process between the AT and the AN the AN can appoint a value that is not requested by the AT.

In a mobile communication system according to an embodiment of the present invention, an AT, in an AT-initiated state, transmits a configuration request message including a list of values that the AT wants to use for configuration attributes of all protocols or applications under negotiation. However, in the case of some configuration attributes, the list of the values to be used may have such a large size that the AT cannot include all supportable attribute values in the transmitted configuration request message.

Therefore, according to an embodiment of the present invention, in an AT-initiated state, the AT and the AN separately define configuration attributes, for which it is difficult to negotiate by using the conventional configuration request message.

According to the present invention, in order to transmit a configuration request message including the configuration attributes, for which it is difficult to negotiate by using the conventional configuration request message, in an AT-initiated state, the AT does not insert the attribute values that the AT wants to use, but inserts partial information of the configuration attributes, for example, an attribute ID, into the configuration request message, and then transmits the configuration request message including only the partial information, which is defined as an enhanced configuration request message, as used herein. Then, the AT can wait for a response including a value that the AN prefers from among corresponding configuration attributes requested through the enhanced configuration request message.

According to the present invention, upon receiving a configuration request message including the configuration attributes, for which it is difficult to negotiate by using the conventional configuration request message, from the AT in an AT-initiated state, the AN can appoint a value that the AN wants to use for the configuration attributes by transmitting an enhanced configuration response message.

Table 1 below shows an example of an enhanced configuration response message according to the present invention. For a particular configuration attribute assured in advance between the AT and the AN, the AN can transmit an enhanced configuration response message having a structure as defined by Table 1. By using the enhanced configuration response message, the AN can appoint an attribute value to be used by the AT for a particular configuration attribute in the AT-initiated state.

TABLE 1

| Field | Length (bits) |
|---|---|
| MessageID | 8 |
| TransactionID | 8 |

Zero or more instances of the
following record

| | |
|---|---|
| AttributeRecord | Attribute dependent |

In Table 1, the MessageID field has a value of a message identifier that implies an enhanced configuration response message, and the TransactionID corresponds to an execution identifier for discriminating one enhanced configuration response message from other enhanced configuration response messages in order to avoid confusion between the messages. The AttributeRecord field has a structure including an attribute ID and an attribute value of a configuration attribute that the AN wants to appoint by using the enhanced configuration response message.

According to the present invention, after receiving the enhanced configuration request message, the AT must use only the attribute value appointed by the AN for the configuration attribute included in the enhanced configuration request message. To this end, the AT must either support all attribute values for which the AT and AN assured their use of an enhanced configuration response message or notify partial information of the supportable attribute values to the AN in advance.

According to the present invention, only when the AT either can support all attribute values for the configuration attributes for which the AT and AN assured their use of an enhanced configuration response message or know partial information of the supportable attribute values in advance, can the AN transmit the enhanced configuration response message.

The configuration attributes for which the AT and AN assured their use of an enhanced configuration response message may be either defined in a standard for a mobile communication system before the session negotiation between the AN and the AT or notified to the AT by the AN before the session negotiation.

Table 2 below shows an example of a configuration attribute by which the AN can perform a session negotiation through the AttributeRecord field within the enhanced configuration response message of Table 1 according to the present invention. The AN transmits the AttributeRecord field within enhanced configuration response message as shown in Table 1 and the AttributeRecord field including configuration attributes as shown in Table 2. From among the fields of the StreamAppSubtypeMapping configuration attribute shown in Table 2, the Length field indicates a length of an attribute value list or an attribute value for the StreamAppSubtypeMapping configuration attribute transmitted through a configuration request message or a configuration response message by an AT or an AN. The AttributeID field includes an identifier for discriminating the StreamAppSubtypeMapping configuration attribute from the other configuration attributes. The StreamID field and the ApplicationSubtype field include an application identifier to be used by the AT or AN and a stream identifier for discriminating data of the corresponding application from data of other applications, respectively.

TABLE 2
StreamAppSubtypeMapping configuration attribute

| Field | Length (bits) | Default |
|---|---|---|
| Length | 8 | N/A |
| AttributeID | 8 | N/A |

Zero or more occurrences of the
following record:

| | | |
|---|---|---|
| StreamID | 8 | 0 |
| ApplicationSubtype | 16 | 0x0000 |

An AT can support more than 250 stream identifiers and more than 7 applications, and can use any stream for one application. However, the AT does not know the application-stream combination selected by the AN. Therefore, in the configuration request message the AT must consider and insert all of the more than 1700 supportable combinations that can be selected by the AN for the StreamAppSubtypeMapping configuration. attribute. In order to reduce such an overhead, the StreamAppSubtypeMapping configuration attribute is used as a configuration attribute for negotiation using an enhanced configuration response message.

Before transmitting a configuration request message for the StreamAppSubtypeMapping configuration attribute, the AT transmits information on all the applications supported by the AT to the AN by using another configuration attribute.

Thereafter, the AT transmits to the AN a configuration request message including only partial information of the StreamAppSubtypeMapping configuration attribute, for example, only an attribute ID. Upon receiving the configuration request message including only the partial information, the AN may transmit an enhanced configuration response message including a StreamAppSubtypeMapping configuration attribute, which indicates an application that the AN wants to use and a stream identifier of the application by using type information of supportable applications previously transmitted by the AT.

Table 3 below shows another example of a configuration attribute using an enhanced configuration response message according to the present invention.

From among the fields of the StreamConfiguration configuration attribute shown in Table 3, the Length field indicates a length of an attribute value list or an attribute value for the StreamConfiguration configuration attribute transmitted through a configuration request message or a configuration response message by an AT or an AN. The AttributeID field includes an identifier for discriminating the StreamConfiguration configuration attribute from the other configuration attributes. The ValueID field is an identifier for discriminating one attribute value set from other attribute value sets in a list of attribute values of Stream0Application, Stream1Application, Stream2Application and Stream3Application, requested by the AT. The Stream0Application, Stream1Application, Stream2Application and Stream3Application include identifiers of applications to be used in relation to stream 0, stream 1, stream 2 and stream 3, respectively.

TABLE 3
StreamConfiguration configuration attribute

| Field | Length (bits) | Default |
|---|---|---|
| Length | 8 | N/A |
| AttributeID | 8 | N/A |

One or more of the following record:

| | | |
|---|---|---|
| ValueID | 8 | N/A |
| Stream0Application | 16 | 0x0000 |
| Stream1Application | 16 | 0xffff |
| Stream2Application | 16 | 0xffff |
| Stream3Application | 16 | 0xffff |

Before transmitting a configuration request message for the StreamConfiguration configuration attribute, the AT transmits information on all the applications supported by the AT to the AN by using another configuration attribute. Thereafter, the AT transmits to the AN an enhanced configuration request message including only partial information of the StreamConfiguration configuration attribute, for example, only an attribute ID. Upon receiving the enhanced configuration request message including only the partial information, the AN may transmit an enhanced configuration response message including a StreamConfiguration configuration attribute, which indicates an application that the AN wants to use and a stream identifier of the application by using type information of supportable applications previously transmitted by the AT.

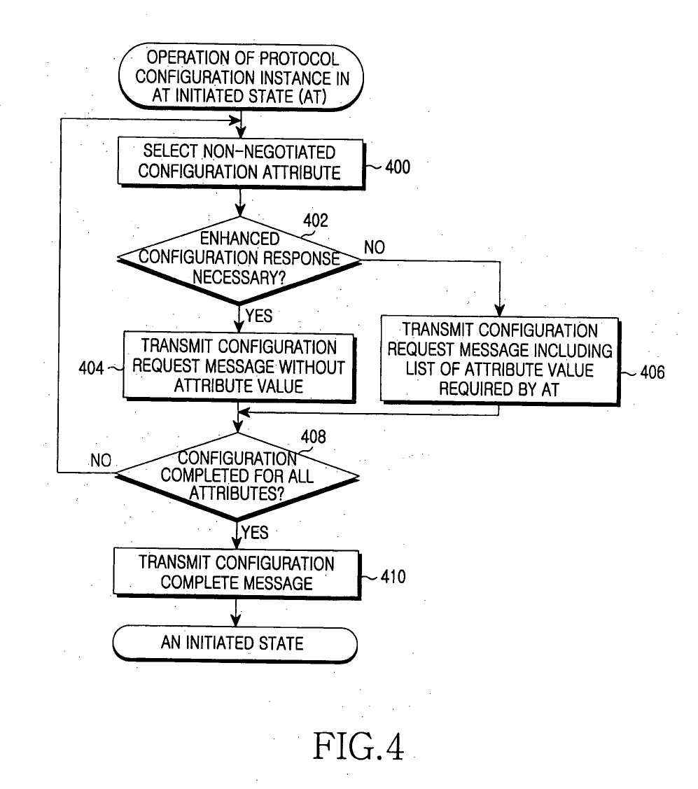

FIG. 4 illustrates an operation of a protocol configuration instance by an AT in an AT-initiated state according to the present invention. In step 400, the AT selects a configuration attribute, for which the AT has not exchanged a configuration request message and a configuration response message with the AN, from the configuration attributes for which the AT wants to negotiate. In step 402, the AT determines whether the configuration attribute selected in step 400 is a configuration attribute for which the AT and the AN assured their use of an enhanced configuration response process, that is, if the selected configuration attribute is a configuration attribute for which the AT and the AN assured their use of an enhanced configuration request message and an enhanced configuration response message. It is assumed that the AT and the AN made a preliminarily assurance and know which configuration response message is to be used by each configuration response message. As a result of the determination in step 402, when the selected configuration attribute is a configuration attribute for which the AT and AN assured their use of an enhanced configuration response message, the AT transmits an enhanced configuration response message including only an attribute ID of the configuration attribute without an attribute value in step 404.

In contrast, as a result of the determination in step 402, when the selected configuration attribute is a configuration attribute for which the AT and the AN have not assured to use an enhanced configuration response message, the AT transmits a configuration request message including a list of attribute values which the AT wants for the configuration attribute in step 406. Then, in step 408, the AT determines whether negotiation has been performed for all the configuration attributes. When any more configuration requests are necessary, the AT returns to step 400 and continues performing the configuration negotiation. In contrast, when any more configuration requests are unnecessary, the AT proceeds to step 410 in which the AT transmits a configuration complete message and shifts into the AN-initiated state.

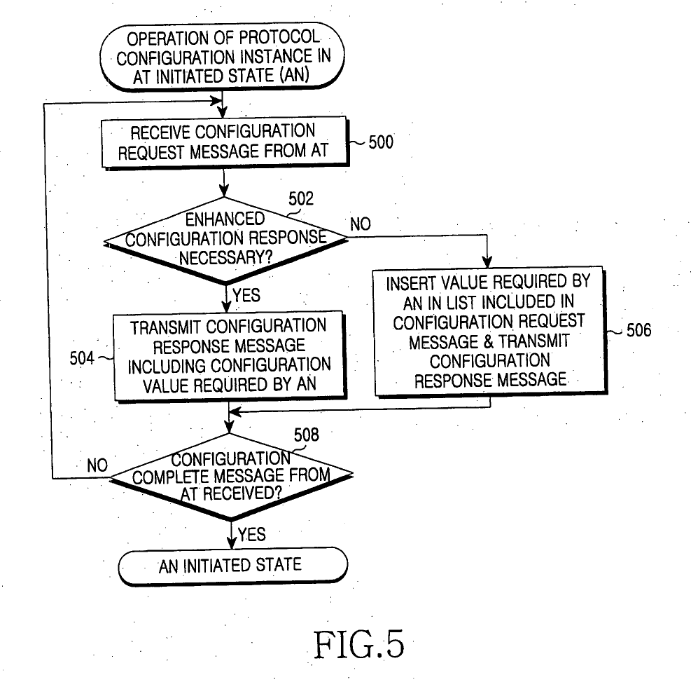

FIG. 5 illustrates an operation of a protocol configuration instance by an AN in an AT-initiated state according to the present invention.

In step 500, the AT receives a configuration request message from the AT. In step 502, the AN determines whether the configuration attribute included in the configuration request message received in step 500 is a configuration attribute for which the AT and AN assured their use of an enhanced configuration response message. It is assumed that the AT and the AN made a preliminary assurance and know about which configuration response message is to be used by each configuration response message. As a result of the determination in step 502, when the configuration attribute is a configuration attribute for which the AT and AN assured they would use an enhanced configuration response message, the AN transmits an enhanced configuration response message including an attribute value that the AN wants to use for the corresponding configuration attribute in step 504. In contrast, as a result of the determination in step 502, when the configuration attribute is a configuration attribute for which the AT and AN have not assured their use of an enhanced configuration response message, the AN selects one attribute value that the AN wants to use in the list of attribute values included in the configuration request message, which the AT wants for the configuration attribute, and then transmits a configuration response message including the selected attribute value in step 506. Thereafter, in step 508, the AN determines whether it has received a configuration complete message from the AT. When the AN has not received a configuration complete message from the AT, the AN returns to step 500 and continues performing the configuration negotiation. When the AN has received a configuration complete message from the AT, the AN shifts into the AN-initiated state.

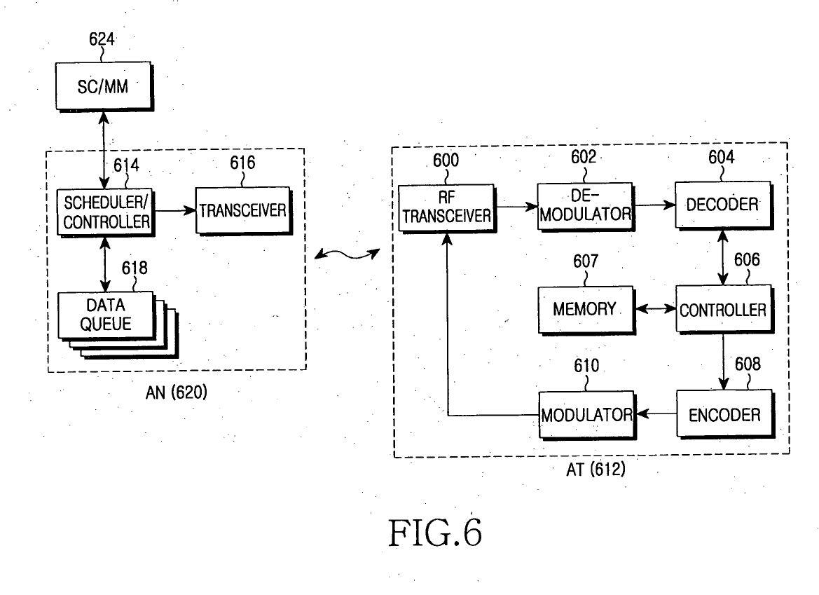

FIG. 6 illustrates a construction of a mobile communication system according to the present invention, for example, a CDMA 2000 1x EV-DO network.

The mobile communication system shown in FIG. 6 includes an AT 612 of a user and an AN 620 for exchanging data with the AT 612 through a wireless network. The AN 620 includes an Access Network Controller (ANC) and an Access Network Transceiver (ANT), which constitute a Radio Access Network (RAN) of a CDMA 2000 1x EV-DO network. A Session Control/Mobility Management (SC/MM) unit 624 negotiates with the AT 612 for session information to be used for communication according to a session negotiation process disclosed in the present invention, which will be referred to as a “session controller.”

The AN 620 includes a transceiver unit 616, a data queue 618 and a scheduler/controller 614. The transceiver unit 616 includes a radio frequency unit for frequency down-converting or up-converting in order to transmit user data or a message, a modulator/demodulator for modulating received data or demodulating data to be transmitted, and an encoder/decoder for encoding or decoding the modulated/demodulated data. The data queue 618 stores the received user data or the message. The scheduler/controller 614 selects and transmits data of a particular user and a particular queue in consideration of the quantity of data of each queue, channel states of ATs, service characteristics and fairness, for example.

The AT 612 and the session controller (SC/MM) 624 are equipped with a session negotiation algorithm in order to perform the session negotiation according to the method described above with reference to FIGS. 4 and 5. Further, although the session controller 624 may be provided in either the packet control function unit or the AN 620, the present invention is based on an assumption that the session controller 624 is included in the AN 620 and, a unit including the AN 620 and the session controller 624 is referred to as a session negotiation apparatus, for the sake of convenience.

Further, the AT 612 includes an RF transceiver unit 600 for communication with the AN 620 through a wireless channel, a demodulator 602 for demodulating user data or a message received through the RF transceiver unit 600, a decoder 604 for decoding the demodulated data or message, a controller 606 for controlling the general operation of the AT and negotiating with the session controller 624 for session information to be used in communication, a memory 607 for storing the negotiated session information or the user data to be transmitted/received, an encoder 608 for encoding the user data or generated message, and a modulator 610 for modulating the encoded user data or message. Further, a unit including the RF transceiver unit 600, the demodulator 602, the decoder 604, the encoder 608 and the modulator 610 of the AT 612 may be called a “transceiver unit” for communication with the AN 620.

For session control and session negotiation with the SC/MM 624, the controller 606 of the AT 612 either generates session negotiation-related information in a message format or extracts session negotiation-related information from a received message. Further, the controller 606 stores parameters related to the session information and information corresponding to change in the session information in the memory 607. Further, the controller 606 stores configuration attributes for which the AT and AN 620 assured to use the enhanced configuration request message in the memory 607. Moreover, the controller 606 stores identifiers and a list of configuration attributes for which the AI and AN 620 assured their use of the enhanced configuration request message in the memory 607.

In order to transmit particular configuration attributes for which the AT and AN 620 assured to use an enhanced configuration request message while performing the session configuration in the AT-initiated state, the controller 606 does not insert the configuration attribute values that the AT wants to use, but inserts partial information of the configuration attributes, for example, an attribute ID, into the enhanced configuration request message, and then transmits the enhanced configuration request message including only the partial information to the session controller 624. Further, upon receiving an enhanced configuration response message of the present invention from the session controller 624 received the enhanced configuration request message, the controller 606 stores the session configuration attribute values included in the enhanced configuration response message in the memory 607 and performs session configuration with the AN 620 by using the configuration attribute values. At this time, after storing the attribute values included in the enhanced configuration response message in the memory 607, the controller 606 performs session negotiation with the AN 620 for the next session by using the attribute values.

The session controller 624 receives a configuration request message including the configuration attributes, which the AT 612 wants to use for a configuration instance of a protocol or application newly generated at the time of session configuration in an AT-initiated state, and negotiates with the AT 612 for the session.

When the SC/MM 624 receives a configuration request message including particular configuration attributes from the AT 612 in the AT-initiated state, the SC/MM 624 transmits an enhanced configuration response message having a structure including an attribute ID and an attribute value of the configuration attribute to be used to the AT 612 as shown in Tables 2 and 3.

At this time, the AT 612 is required either to support all attribute values for configuration attributes for which the AT and AN 620 assured to use the enhanced configuration response message as described above or to notify partial information of the supportable values to the SC/MM 624 through the AN 620.

According to the present invention as described above, it is possible to more efficiently perform session negotiation even when the AT and the session controller want to use different configuration attribute values in the session configuration process.

While the invention has been shown and described with reference to certain exemplary embodiments thereof, it will be understood by those skilled in the art that various changes in form and details may be made therein without departing from the spirit and scope of the invention as defined by the appended claims.

1. A method for session negotiation by an Access Terminal (AT) in a mobile communication system, the method comprising the steps of:
selecting a configuration attribute for which negotiation has not been completed, from among a plurality of configuration attributes for session negotiation between the AT and a session controller during the session negotiation in an AT-initiated state;
determining whether an enhanced configuration request message is required for the selected configuration attribute; and
transmitting by the AT an enhanced configuration request message when the enhanced configuration request message is required for the selected configuration attribute, said enhanced configuration request message including an IDentifier (ID) of the selected configuration attribute without a list of attribute values that the AT wants to use for the selected configuration attribute.

2. The method as claimed in claim 1, further comprising:
receiving from a session controller an enhanced configuration response message including an attribute value that the session controller wants to use for the selected configuration attribute, after transmitting the enhanced configuration request message; and
storing the attribute value included in the enhanced configuration response message.

3. The method as claimed in claim 2, wherein the enhanced configuration response message further comprises:
a message ID for identifying the enhanced configuration response message;
a transaction ID for discriminating the enhanced configuration response message from other enhanced configuration response messages; and
an attribute record including the attribute ID and the attribute value that the session controller wants to use for the selected configuration attribute.

4. The method as claimed in claim 1, further comprising receiving from a session controller a notification of configuration attributes, for which the AT and the session controller have assured their use of the enhanced configuration request message.

5. The method as claimed in claim 1, wherein the configuration attributes, for which the AT and a session controller have assured their use of the enhanced configuration request message, are defined in a standard for the mobile communication system before the session negotiation.

6. The method as claimed in claim 1, further comprising transmitting, when the AT and a session controller have not assured their use of the enhanced configuration request message for the selected configuration attribute, transmitting a configuration request message including a list of attribute values that the AT wants to use for the selected configuration attribute to the session controller.

7. The method as claimed in claim 6, further comprising:
receiving, from the session controller, a configuration response message including an attribute value that the session controller wants to use for the selected configuration attribute from among attribute values in the list included in the configuration request message, after transmitting the configuration request message; and
performing session negotiation with the session controller by using a attribute value included in the received configuration response message.

8. A method for session negotiation by a session controller in a mobile communication system, the method comprising the steps of:
receiving a message from an Access Terminal (AT) during a session configuration process between the AT and the session controller in an AT-initiated state AT; and
inserting, when the received message is an enhanced configuration request message, which includes an attribute IDentifier (ID) without a list of attribute values that the AT wants to use, the attribute ID included in the enhanced configuration request message and an attribute value that the session controller wants to use into an enhance configuration response message corresponding to the enhanced configuration request message, and then transmitting the enhance configuration response message to the AT.

9. The method as claimed in claim 8, further comprising, when the received message is a configuration request message including a list of attribute values that the AT wants to use, selecting and inserting an attribute value that the session controller wants to use in the list into an configuration response message corresponding to the configuration request message, and then transmitting a configuration response message to the AT.

10. The method as claimed in claim 8, wherein the enhanced configuration response message comprises:
a message IDentifier (ID) for identifying the enhanced configuration response message;
a transaction ID for discriminating the enhanced configuration response message from other enhanced configuration response messages; and
an attribute record including the attribute ID and the attribute value that the session controller wants to use for the selected configuration attribute.

11. A method for session negotiation in a mobile communication system, the method comprising the steps of:
selecting a configuration attribute by an Access Terminal (AT) for session negotiation between the AT and a session controller during the session negotiation in an AT-initiated state;
transmitting, when the AT and the session controller have assured their use of an enhanced configuration request message for the selected configuration attribute, an enhanced configuration request message including an IDentifier (ID) of the selected configuration attribute without a list of attribute values that the AT wants to use for the selected configuration attribute to the session controller by the AT;
when the session controller has received the enhanced configuration request message, inserting the attribute ID included in the enhanced configuration request message and an attribute value that the session controller wants to use into an enhanced configuration response message corresponding to the enhanced configuration request message, and then transmitting by the session controller the enhanced configuration response message to the AT; and
receiving the enhanced response message and performing by the AT session negotiation with the attribute value included in the enhanced configuration response message.

12. The method as claimed in claim 11, further comprising transmitting by the AT, when the AT and the session controller have not assured their use of the enhanced configuration request message for the configuration attribute selected by the AT, a configuration request message including a list of attribute values that the AT wants to use for the selected configuration attribute to the session controller.

13. The method as claimed in claim 12, further comprising, when the message received from the AT is the configuration request message including a list of attribute values that the AT wants to use, selecting and inserting an attribute value that the session controller wants to use in the list into a configuration response message corresponding to the configuration request message, and then transmitting the configuration response message to the AT by the session controller.

14. The method as claimed in claim 11, wherein the enhanced configuration response message comprises:
a message IDentifier (ID) for identifying the enhanced configuration response message;
a transaction ID for discriminating the enhanced configuration response message from other enhanced configuration response messages; and
an attribute record value including the attribute ID and the attribute value that the session controller wants to use for the selected configuration attribute.

15. A system for performing session negotiation in a mobile communication system, the system comprising:
an Access Terminal (AT) for selecting a configuration attribute describing parameters to be used for each protocol for session negotiation between the AT and a session controller during the session negotiation in an AT-initiated state, and transmitting an enhanced configuration request message including an IDentifier (ID) of the selected configuration attribute without a list of attribute values that the AT wants to use for the selected configuration attribute to an Access Network when the AT and a session controller have assured their use of an enhanced configuration request message for the selected configuration attribute; and
the session controller for receiving the enhanced configuration request message from the AT through the Access Network, inserting the attribute ID included in the enhanced configuration request message and an attribute value that the session controller wants to use into an enhance configuration response message corresponding to the enhanced configuration request message, and then transmitting by the session controller the enhance configuration response message to the AT.

16. The system as claimed in claim 15, wherein, when the AT and the session controller have not assured their use of an enhanced configuration request message for the configuration attribute selected by the AT, the AT transmits to the session controller a configuration request message including a list of attribute values that the AT wants to use for the selected configuration attribute.

17. The system as claimed in claim 16, wherein, when the message received from the AT is the configuration request message including the list of attribute values that the AT wants to use, the session controller selects and inserts the attribute value that the session controller wants to use in the list into an configuration response message corresponding to the configuration request message, and then transmits the configuration response message to the AT.

18. The system as claimed in claim 15, wherein the enhanced configuration response message further comprises:
a message Identifier (ID) for identifying the enhanced configuration response message;
a transaction ID for discriminating the enhanced configuration response message from other enhanced configuration response messages; and
an attribute record value including the attribute ID and the attribute value that the session controller wants to use for the selected configuration attribute.

19. An apparatus for performing session negotiation to communicate with an Access Terminal (AT) in a mobile communication system, the apparatus comprising:
a transceiver unit for performing wireless communication with the AT; and
a session controller for, when an enhanced configuration request message is received, which includes an IDentifier (ID) of a configuration attribute without a list of attribute values that the AT wants to use, inserting an attribute ID included in the enhanced configuration request message and an attribute value that the session controller wants to use into an enhance configuration response message corresponding to the enhanced configuration request message, transmitting the enhance configuration response message to the AT, and storing attribute values for the session configuration between the AT and the session controller.

20. The apparatus as claimed in claim 19, wherein, when an configuration request message including a list of attribute values that the AT wants to use has been received through the transceiver unit, the session controller selects and inserts the attribute value that the session controller wants to use in the list into an configuration response message corresponding to the configuration request message, and then transmits the configuration response message to the AT.

21. The apparatus as claimed in claim 19, wherein the enhanced configuration response message further comprises:
a message IDentifier (ID) for identifying the enhanced configuration response message;
a transaction ID for discriminating the enhanced configuration response message from other enhanced configuration response messages; and
an attribute record value including the attribute ID and the attribute value that the session controller wants to use for the selected configuration attribute.

22. An Access Terminal (AT) apparatus for performing session negotiation in a mobile communication system, the apparatus comprising:
a transceiver unit for performing wireless communication with an Access Network Transceiver System (ANTS);
a controller for selecting a configuration attribute from among configuration attributes for session negotiation between an AT and a session controller during the session negotiation in an AT-initiated state and for determining whether an enhanced configuration request message is required for the selected configuration attribute, transmitting the enhanced configuration request message including an IDentifier (ID) of the selected configuration attribute without a list of attribute values that the AT wants to use for the selected configuration attribute through the transceiver unit when the enhanced configuration request message is required for the selected configuration attribute, and, when an enhanced configuration response message including the ID included in the enhanced configuration request message and attribute values that the session controller wants to use for the selected configuration attribute has been received through the transceiver unit, storing a attribute value included in the enhanced configuration response message; and
a memory for storing information on the negotiated session configuration, the ID of the selected configuration attribute, and the attribute value included in the enhanced configuration response message.

23. The apparatus as claimed in claim 22, wherein the controller transmits a configuration request message including a list of attribute values that the AT wants to use for a configuration attribute, when the enhanced configuration request message is not required for the selected configuration attribute, through the transceiver unit, and receives a configuration response message including the attribute values that the session controller wants to use from among attributes in the list in response to the configuration request message.

24. The apparatus as claimed in claim 22, wherein the controller receives a notification of configuration attributes, for which the AT and the session controller have assured their use of an enhanced configuration request message, from the session controller.
